(19) United States
(12) Patent Application Publication
(10) Pub. No.: US 2009/0127330 A1
(43) Pub. Date: May 21, 2009

(54) Method for controlling the production of an apparatus for making drinks

(75) Inventor: Arturo Morgandi, Bergamo (IT)

Correspondence Address: HUSCH BLACKWELL SANDERS LLP, 190 CARONDELET PLAZA, SUITE 600, ST. LOUIS, MO, 63105-3441, US

(73) Assignee: Tenacta Group S.P.A., Azzano S. Paolo (IT)

(21) Appl. No.: 11/916,840

(22) PCT Filed: Jun. 10, 2005
(86) PCT No.: PCT/IT05/00328

§ 371 Date: Jan. 17, 2008

(51) Int. Cl. G06K 5/00; G06K 19/06

(52) U.S. Cl. 235/380; 235/492

(57) ABSTRACT

A method for controlling the production of an apparatus for making drinks which is adapted to be used with a predetermined type of product container has the steps of organising containers in a plurality of packages (90). Each of the packages (90) is associated with an electronic card (100) identifying the predetermined type of container. For each electronic card associated by a user with the apparatus (1), the apparatus checks whether the electronic card associated by the user conforms with the electronic card (100) identifying the predetermined type of container and, if so, enables the apparatus (1) to make a predetermined number of drinks and disables the electronic card (100) for further readings.

The present invention relates to a method for controlling the production of an apparatus for making drinks.

The present invention further relates to an apparatus for making drinks, an electronic card and a package of product containers that allow such method to be carried out.

The present invention relates to apparatuses for making drinks and in particular, for making hot drinks such as, for example, coffee, tea, milk, chocolate, cappuccino, barley coffee, infusion, which are adapted to operate with a product pre-packed into special single-dose containers, such as for example bags, wafers or capsules.

Apparatuses of this type known in the art typically comprise a water tank at atmospheric pressure, a boiler (or an instant hot water generator) for heating the water comprising an electrical resistor, a pump for feeding water from the tank to the boiler, a seat for housing the product container and a-duct for providing hot water under pressure from the boiler to the seat, so as to produce the hot drink by means of the flow of hot water through the product contained in the container housed in the seat.

The boiler is typically associated with a temperature sensor for directly or indirectly measuring the temperature of the water contained therein and with control means adapted to switch on/switch off the electrical resistance based on the temperature detected by the temperature sensor so as to keep the water temperature into the boiler at a predetermined temperature.

The Applicant has noted that, in general, in order to optimise the quality of a hot drink, it is important that an apparatus for making hot drinks be designed on the basis of the features of a given type of product container. For example, in the case of coffee, it is important that the temperature and the pressure of water reaching the container housed in the seat be adjusted according to the type of coffee blend contained in the container, to the quantity of product contained in the container, to the type of coffee grinding and to the material used for the container. For example, in the case of wafers or bags, it is important that the temperature and the pressure of water be adjusted according to the quality, thickness and size of the filtering paper used to make the wafer or bag. Moreover, it is important that the seat of the apparatus be shaped and sized on the basis of the size and shape of the container to be housed.

Once the apparatus has been designed on the basis of the features of a given type of product container, it is important that a user uses the apparatus with such a type of container.

In fact, in case of use of the apparatus with containers having features considerably differing from those based on which it has been designed, the quality of the hot drink can be greatly affected. Moreover, the safety of apparatus could be risked.

The Applicant faced the technical problem of avoiding such technical problem.

In a first aspect thereof, the present invention therefore relates to a method for controlling the production of an apparatus for making drinks which is adapted to be used with a predetermined type of product container having predetermined features, said method comprising the steps of

a) organising containers of said predetermined type in a plurality of packages each comprising a number N of said containers, where N is an integer greater than 1;

b) associating each of said packages with at least one electronic card identifying said predetermined type of container; and

c) at said apparatus for making drinks, for each electronic card associated by a user with said apparatus, checking whether the electronic card associated by the user conforms with the electronic card identifying said predetermined type of container and, in the affirmative case,

c1) enabling the apparatus to make a predetermined number of drinks;

c2) disabling the electronic card for further readings.

Given an apparatus for making drinks which has been designed taking into account a predetermined type of container of a predetermined product, the method of the invention provides that each package of N containers having such features is associated with at least one electronic card identifying that type of container and that the apparatus is enabled to make a predetermined number of drinks only after recognition of an electronic card identifying that type of container. Thus, the method of the invention leads a user to use an apparatus for making drinks only with containers having predetermined features based on which the apparatus has been designed, thus allowing optimising the quality of the drinks made by the apparatus and preserving the safety of the apparatus itself.

Step c2) of disabling the electronic card prevents the user from reusing the card for re-enabling the apparatus to make other drinks.

Typically, in step c1), the apparatus is enabled to make at least N drinks.

In an embodiment, in step c1) the apparatus is enabled to make also a number of spare additional drinks with respect to said predetermined number. This allows providing the user with the possibility of making some more drinks, for example in case of mistakes.

Advantageously, said electronic card is indicative of a predetermined number M of drink supplies. In this case, in step c1) said predetermined number of drinks is at least equal to M. Typically, said predetermined number of drinks is equal to M.

Advantageously, number M is equal to at least N. The case of M greater than N allows providing the user with the possibility of making some more drinks with respect to N, for example in case of errors.

However, the method of the invention also provides for the case in which the electronic card is indicative of a predetermined number M of supplies of drink less than N (M<N). In this case, step b) will advantageously be carried out by associating each of said packages with more electronic cards identifying said predetermined type of container so that, as a whole, the associated cards are indicative of a number of drink supplies at least equal to N. For example, in the case of packages with 100 containers each (N=100) and of cards indicative of a number of supplies equal to 50 (M=50), each package will be associable with two of such cards and the user will be able to enable the apparatus for making 100 drinks by successively associating with it the two cards.

In an embodiment, said electronic card comprises means indicative of said predetermined number M of drink supplies.

According to this embodiment, the method advantageously comprises also the step c3) of determining from said indicative means the predetermined number M of drink supplies.

Advantageously, the electronic card comprises a casing and is adapted to identify said containers having said predetermined features by a suitable shape of the casing. In this case, the step c) of checking the identity of the electronic card is advantageously carried out by suitable shape recognition.

According to a variant, the electronic card comprises means adapted to store an identification code of said electronic card. In this case, the step c) of checking the identity of the electronic card is advantageously carried out by recognition of said identification code.

According to an embodiment, in the electronic card the indicative means of a predetermined number M of drink supplies comprises means adapted to store said number M. In this case, the step c3) is advantageously carried out by a reading of said number by said storing means.

According to another embodiment, the indicative means of a predetermined number M of drink supplies comprises an electrical resistor having a predetermined resistance value, indicative of number M. In this case, the step c3) is advantageously carried out by a determination of the resistance value of the resistor.

According to a variant, the indicative means of a predetermined number M of drink supplies comprises a fuse having a predetermined blow-out current value, indicative of number M. In this case, the step c3) is advantageously carried out by a determination of the fuse blow-out current.

Advantageously, the electronic card comprises means adapted to enable the disabling of the electronic card by said apparatus. According to an embodiment, such means comprises an electrical resistor and a fuse electrically connected to one another. In this case, the step c2) is advantageously carried out by supplying the electronic card with a current of a suitable intensity for blowing out the fuse.

Advantageously, in the electronic card, the resistor of the indicative means of the predetermined number M is the same resistor of the disabling means.

Advantageously, in the electronic card, the fuse of the indicative means of the predetermined number M is the same fuse of the disabling means.

Advantageously, said containers are single-dose containers.

Advantageously, said containers are selected from the group comprising wafers, bags and capsules.

Advantageously, said predetermined features of said containers are indicative of at least one of the following features: type of blend used for the product, amount of product contained in the container, type of product grinding, size of the product leaves or granules, material used for the container, shape of the container, size of the container, manufacturer and/or retailer of the container, manufacturer and/or retailer of the product, manufacturer and/or retailer of the apparatus.

In a second aspect thereof, the present invention also relates to an apparatus for making drinks adapted to be used with a predetermined type of product container having predetermined features, said apparatus comprising a processing unit and recognizing means adapted to identify an electronic card identifying said type of product container, wherein, when said recognizing means identifies an electronic card complying with the electronic card identifying said type of container, said processing unit is adapted to:
enable the apparatus to make a predetermined number of drinks; and
disable the electronic card for further readings.

Typically, the apparatus also comprises
a water heating device;
a seat adapted to receive a product container of said predetermined type; and
a duct for feeding hot water from the device to the seat.

In an embodiment, when said recognizing means identifies an electronic card complying with the electronic card identifying said type of container, said processing unit is also adapted to enable the apparatus for making a number of spare drinks, additional with respect to said predetermined number. This allows giving the user the possibility of making some more drinks as compared to said predetermined number, for example in case of mistakes.

Advantageously, the electronic card is indicative of a predetermined number M of drink supplies. In this case, said predetermined number of drinks that the apparatus is enabled to make is at least equal to M. Typically, said predetermined number of drinks is equal to M.

In an embodiment, said electronic card comprises means indicative of said predetermined number M of drink supplies.

According to this embodiment, the processing unit is also advantageously adapted to determine from said indicative means the predetermined number M of supplies.

Advantageously, the electronic card comprises a casing and is adapted to identify said type of container having said predetermined features by a suitable shape of the casing. In this case, the recognizing means of the electronic apparatus is advantageously adapted to identify the electronic card by a suitable shape recognition. According to an embodiment, said recognizing means comprises an opening, having shape complementary to that of the electronic card casing, for receiving the electronic card.

According to an alternative embodiment, the electronic card comprises means adapted to store an identification code of said electronic card. In this case, the recognizing means of the electronic apparatus is advantageously adapted to identify the electronic card by recognition of said identification code.

Advantageously, in the electronic card the indicative means of the predetermined number M of drink supplies comprises means adapted to store said number M. In this case, the processing unit is advantageously adapted-to determine the number M by a reading of said number by said storing means.

Preferably, the indicative means of a predetermined number M of drink supplies comprises an electrical resistor having a predetermined resistance value, indicative of number M. In this case, the processing unit is advantageously adapted to determine number M by a determination of the resistance value of the resistor.

According to a variant, the indicative means of a predetermined number M of drink supplies comprises a fuse having a predetermined blow-out current value, indicative of number M. In this case, the processing unit is advantageously adapted to determine number M by a determination of the fuse blow-out current.

Advantageously, the electronic card comprises means adapted to allow the disabling of the electronic card by said apparatus. According to an embodiment, such means comprises an electrical resistor and a fuse electrically connected to one another. In this case, the processing unit is advantageously adapted to disable the electronic card by supplying the electronic card with a current of a suitable intensity for blowing out the fuse.

In a third aspect thereof, the present invention also relates to an electronic card identifying a type of product container having predetermined features, said card being adapted to be associated with an apparatus for making drinks according to the second aspect of the invention and comprising means adapted to allow the disabling of the electronic card by said apparatus.

Advantageously, the electronic card is indicative of a predetermined number M of drink supplies, with M integer greater than 1.

In an embodiment, the electronic card also comprises means indicative of said predetermined number M of drink supplies.

As regards the structural and functional features of the electronic card, reference shall be made to what described above.

In a fourth aspect thereof, the present invention also relates to a package comprising N product containers of a predetermined type having predetermined features, where N is an integer greater than 1, and an electronic card, identifying said type of container, according to the third aspect of the invention.

As regards the structural and functional features of the electronic card and of the product containers, reference shall be made to what described above.

Further features and advantages of the present invention will appear more clearly from the following detailed description of a preferred embodiment, made with reference to the attached drawings. In such drawings,

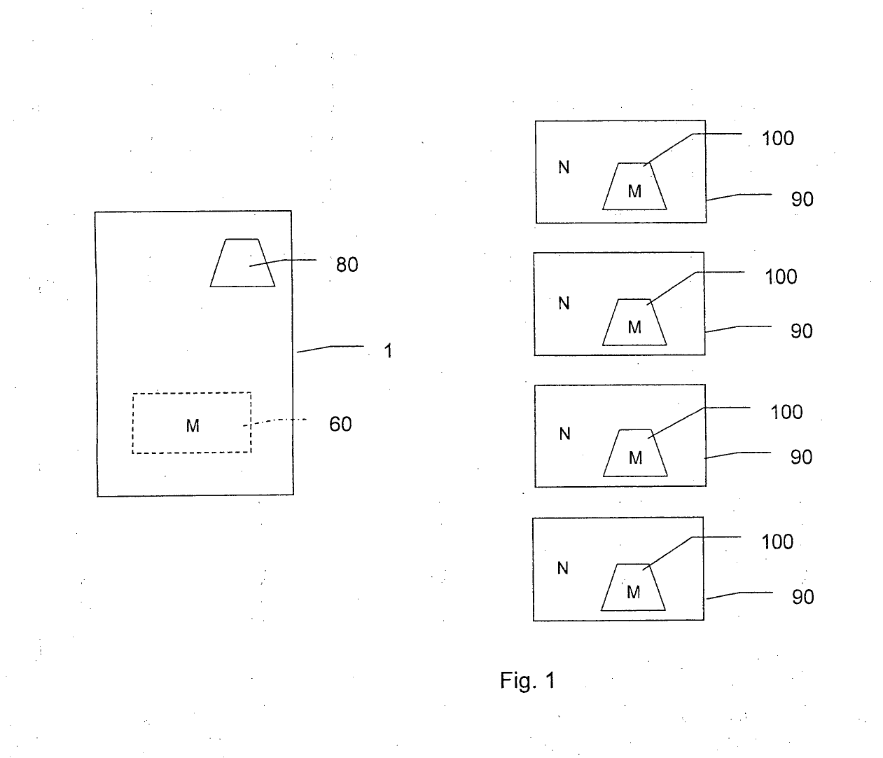

FIG. 1 shows a schematic representation of an apparatus for making drinks and a plurality of packages of product containers according to an embodiment of the invention;

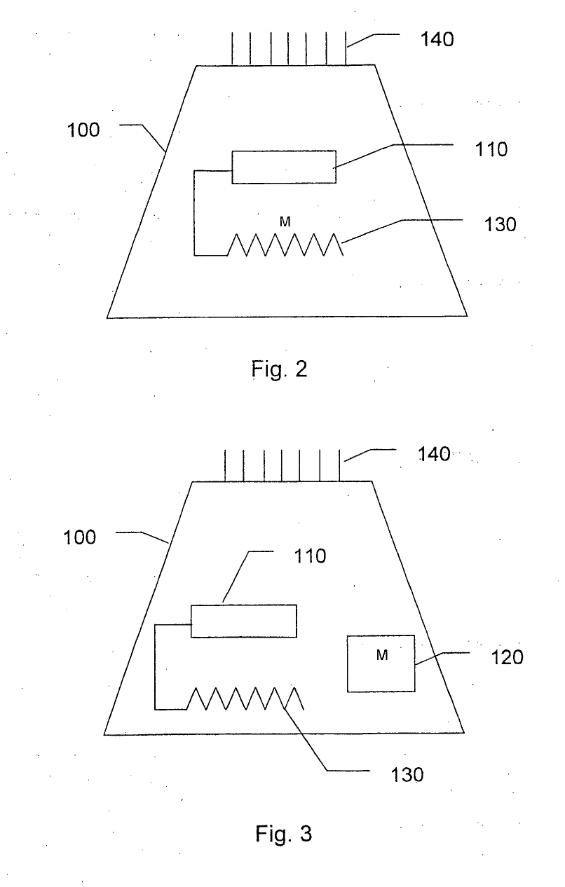

FIG. 2 shows a schematic view of a first embodiment of an electronic card according to the invention;

FIG. 3 shows a schematic view of a second embodiment of an electronic card according to the invention;

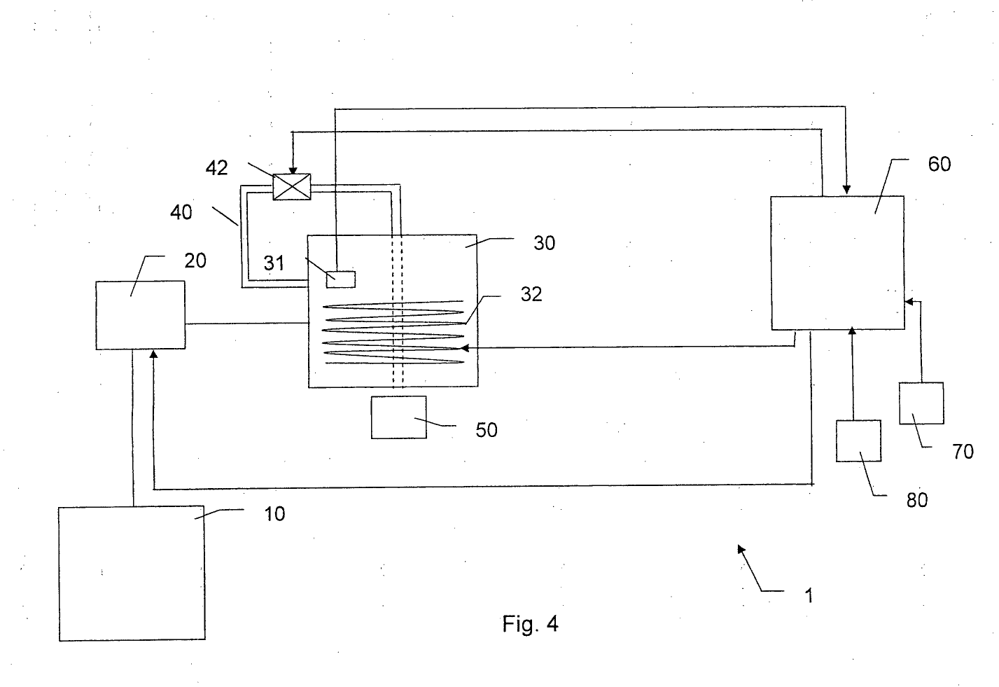

FIG. 4 shows a schematic view of an embodiment of an apparatus for making drinks according to the invention;

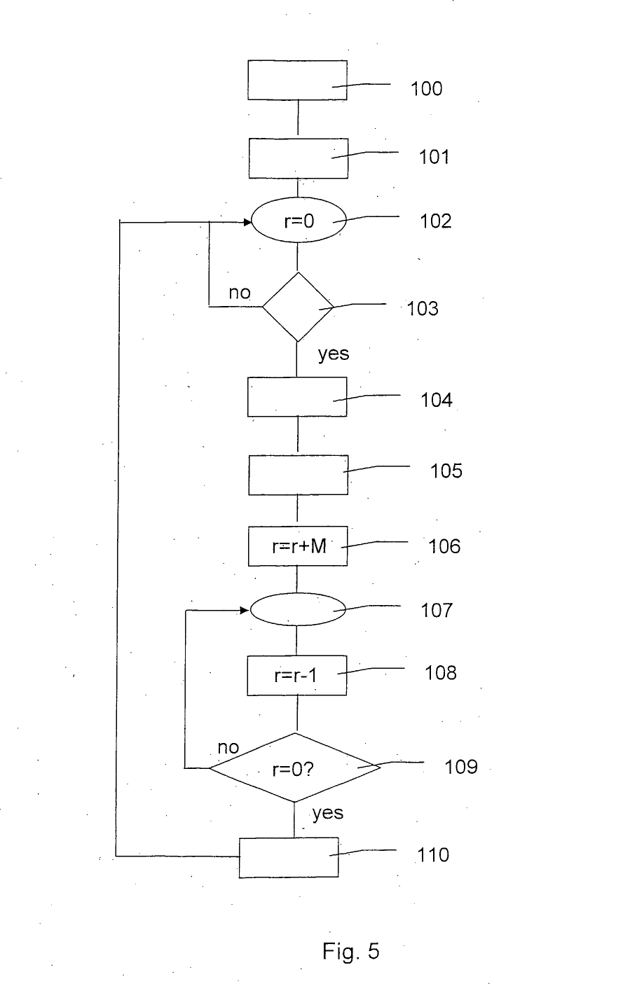

FIG. 5 shows a flow chart exemplifying an embodiment of the method of the invention.

FIG. 1 shows an apparatus 1 for making drinks and a plurality of packages 90 according to an embodiment of the invention. Each package 90 comprises N single-dose containers (not shown) of a predetermined product, with N integer greater than 1, and an electronic card 100.

Apparatus 1 is of the type working with products pre-packed into special single-dose product containers such as, for example, wafers, capsules or bags.

In the example shown in FIG. 4, apparatus 1 comprises a tank 10 for containing water at atmospheric pressure, a water heating device 30 comprising a heat source 32, a pump 20 for feeding water from tank 10 to device 30, a seat 50 for containing a product container for making a hot drink, a duct 40 for feeding hot water from device 30 to seat 50, a temperature sensor 31 associated with device 30, a solenoid valve 42, a processing unit 60, selection means 70 and recognizing means 80.

Device 30 can, for example, be a conventional boiler of the stagnant water type or a conventional instant hot water generator wherein water does not stagnate and is heated by flowing, for example, along a labyrinth path.

Heat source 32 typically is an armoured electrical resistance of the conventional type.

Apparatus 1 advantageously comprises also a safety system (not shown) of the conventional type adapted to cut off the supply to the heat source 32 in the event of overheating of the same.

Temperature sensor 31 is, for example, a conventional negative temperature coefficient (NTC) probe. Moreover, in the illustrated embodiment, it is housed inside device 30 for directly detecting the temperature of water contained into device 30. However, such sensor could also be positioned outside device 30 (for example, in contact with the outer walls of the same) and detect the temperature of the water contained in device 30 indirectly.

Solenoid valve 42, pump 20 and tank 10 are made according to conventional techniques well known in-the art.

Solenoid valve 42 is adapted to block/allow the water flow along duct 40 towards seat 50.

Seat 50 is built in apparatus 1 and is adapted to receive, according to techniques well known in the art, the product container.

As apparatus 1 is switched on, the processing unit 60 is adapted to switch on the heat source 32 and to adjust the temperature of water into device 30 based on the temperature detected by sensor 31, according to techniques known in the art.

Once the optimum temperature of the water contained in device 30 has been reached, suitable indicator means (not shown) indicates to the user that the apparatus is ready for use.

In case of a request of production of hot drink by the user, the processing unit 60 is adapted to activate pump 20 so that it pumps water from tank 10 to device 30 and to open solenoid valve 42 to allow the water flow, at a pressure determined by the thrust of pump 20, towards seat 50.

The drink is made thanks to the arrival of hot water at a predetermined temperature (for example 90° C.) and at a predetermined pressure on seat 50 and to the flow of hot water through the product contained in the container housed in seat 50. An infusion pressure originates at seat 50, generated by the combination of two factors 1) thrust of pump 20 and 2) resistance offered by the product to the water flow through the same.

Apparatus 1 can, for example, be used for making a single hot drink, such as coffee, or more hot drinks such as coffee, tea, hot chocolate, infusions of various types, barley, hot milk, cappuccinos, milk with coffee, etc.

In this second case, apparatus 1 advantageously comprises also the selection means 70 adapted to allow the user to select the desired type of hot drink, among the plurality of hot drinks that can be made by apparatus 1.

In apparatus 1, the temperature and pressure of the water that reaches the product are advantageously adjusted so as to optimise the quality of a hot drink made, considering a predetermined type of product container having predetermined features.

For example, in the case of coffee, the temperature and pressure of the water in apparatus 1 are advantageously adjusted according to the type of coffee blend contained in such type of container, to the quantity of product contained therein, to the type of coffee grinding and to the material used to make such type of container. For example, in the case of a wafer, the water temperature and pressure will be adjusted also according to the quality, thickness and size of the filtering paper used to make the wafer. Moreover, seat 50 of apparatus 1 is advantageously shaped and sized according to the size and shape of the container to be housed.

For example, apparatus 1 is designed so as to optimise its operation with coffee wafers comprising 6.5-7.5 g of finely ground Arabic blend coffee, having round shape, diameter of 43-47 mm and filtering paper of the conventional type.

Thus, going back to the description of FIG. 1, apparatus 1 is advantageously designed so as to optimise its operation with a predetermined type of product container having predetermined features, packages 90 comprise N containers of such type each and electronic card 100 identifies such type of container having such predetermined features.

For example, according to the data considered above, each package 90 can comprise N wafers (e.g., N=50, 75, 100, 150 or 200), each comprising 6.5-7.5 g of finely ground Arabic blend coffee, having round shape, diameter of 43-47 mm and filtering paper of the conventional type.

According to an embodiment of the invention, the electronic card 100 comprises means indicative of a predetermined number M of drink supplies, with M≧N, and means adapted to allow the disabling of the electronic card by apparatus 1. The case of M greater than N allows providing the user with the possibility of making some more drinks, for example in case of mistakes.

According to the embodiment illustrated in FIG. 2, the means indicative of number M and the means for disabling the electronic card 100 are implemented by a fuse 110, an electrical resistor 130 and pins 140 electrically connected to fuse 110, where the resistance value of resistor 130 is used as indicative of number M. For example, a resistance value of 100 ohm will be indicative of M=50, a resistance value of 200 ohm will be indicative of M=75 and so on.

In particular, pins 140 allow a current flow from apparatus 1 to the electronic card 100. Such current can be a “reading current”, having a predetermined intensity that allows apparatus 1 to determine the resistance value of resistor 130, or a “disabling current” having an intensity that allows apparatus 1 to blow but fuse 110.

According to the embodiment illustrated in FIG. 3, the means for disabling the electronic card 100 is implemented by a fuse 110, an electrical resistor 130 and pins 140 electrically connected to fuse 110, whereas the means indicative of number M is implemented by storing means 120, for example a PCB (Printed Circuit Card), wherein number M is stored. The storing means 120 can be connected to the same pins 140 to which fuse 110 is connected, or to different-pins (not shown).

According to the embodiment illustrated in FIG. 3, pins 140 allow a “disabling current” to flow from apparatus 1 to the electronic card 100, having an intensity adapted to blow out fuse 110. Moreover, the same pins 140 (or the other pins not shown) allow a “reading current” to flow from apparatus 1 to the electronic card 100, having an intensity that allows apparatus 1 to read the number M stored by the storing means 120.

In apparatus 1, the processing unit 60 comprises suitable hardware, software and/or firmware means that, when the recognizing means 80 recognises an electronic card 100, is adapted to carry out the following functions:
determining from electronic card 100 the predetermined number M of hot drink supplies;
enabling apparatus 1 to make a number of drinks correlated to M; and
disabling the electronic card 100 for further readings.

In the embodiment of the electronic card 100 of FIG. 2, the processing unit 60 determines number M by sending the “reading current” to the electronic card 100 for determining the resistance value of resistor 130. Afterwards, it disables the electronic card 100 by sending the disabling current adapted to blow out fuse 110.

In the embodiment of the electronic card 100 of FIG. 3, the processing unit 60 determines number M by sending the “reading current” in said storing means 120. Afterwards, it disables the electronic card 100 by sending the disabling current adapted to blow out fuse 110.

In apparatus 1, the recognition of an electronic card 100 identifying a certain type of product container, having predetermined features, can be implemented in different ways.

For example, it can be implemented by shape recognition. In this case, the electronic card 100 can comprise a casing of suitable shape and the recognizing means 80 of apparatus 1 can comprise an opening having a shape complementary to that of the casing of the electronic card 100 so as to receive only electronic cards having such shape.

According to an alternative embodiment, the recognition can be implemented by recognition of a specific identification code.

In this case, the electronic card 100 can comprise means (for example the same storing means 120 shown in the embodiment of FIG. 3) adapted to store such identification code and the recognizing means 80 of the electronic apparatus 1 can comprise, optionally besides an opening for receiving the electronic card 110, suitable hardware, software and/or firmware means in the processing unit 60 adapted to identify the electronic card by reading said identification code from the electronic card 100 itself.

FIG. 5 shows a flow chart exemplifying an embodiment of the method of the invention.

Given an apparatus 1 for making hot drinks designed for optimising the production of a hot drink starting from a type of product container having predetermined features, according to such flow chart:
product containers of said container type are organised in a plurality of packages 90 each comprising a number N of such containers (block 100);
each package 90 is associated with an electronic card 100 identifying that type of container having said predetermined features and indicative of a number M (for example M=N) of drink supplies (block 101);
apparatus 1 is in a status in which it is disabled for the production of hot drinks and a parameter r is set equal to zero (r=0) (block 102);
when apparatus 1 is associated with an electronic card by a user (for example, by introduction of the electronic card in the opening of the recognizing means 80), the processing unit 60 of apparatus 1 checks whether the electronic card associated by the user complies with the electronic card 100 identifying said type of containers (block 103);
if the check of block 103 is negative, apparatus 1 returns to block 102;
if the check of block 103 is positive, the processing unit 60 determines the predetermined number M associated with the electronic card 100 and stores it (block 104);
the processing unit 60 disables the electronic card 100 for further readings (block 105);
the processing unit 60 sets parameter r equal to r+M (r=r+M) and enables (or keeps enabled) apparatus 1 for the production of drinks (block 106);
the processing unit 60 remains in stand-by awaiting for a request of hot drink supply by the user (block 107);
when the user requires the supply of a hot drink, the processing unit 60 provides for making the hot drink and decreases parameter r by 1 (r=r−1) (block 108);
the processing unit 60 checks whether parameter r is equal to zero (r=0) (block 109);.
if at block 109 parameter r is equal to zero, then the processing unit 60 disables apparatus 1 for the production of hot drinks (block 110) and returns to block 102;
if at block 109 parameter r is greater than zero, then the processing unit 60 returns to the stand-by block 107.

Even if not shown, the method of the invention envisages that at any point of the flow chart, the user can associate apparatus 1 with a new electronic card and the procedure can restart from block 103. The value of parameter r indicates the number of drinks that the apparatus is temporarily enabled to dispense. When the processing unit 60 identifies a new electronic card 100, apparatus 1 is enabled to make a number M of drinks that adds to number r of drinks that the apparatus is in the moment enabled to make.

Even if not shown, the method of the invention can also provide for enabling apparatus 1 to make a number Δ of spare drinks, additional with respect to M, for providing the user with the possibility of making some more drinks than number N of containers contained in package 90. For example, the method can provide for the processing unit 60 being adapted
to count the number of spare drinks made by the user;
every time a new electronic card 100 is identified, to check the residual value of spare drinks available to the user; and
if such residual value is, for example, less than Δ or than a predetermined threshold value, to re-enable apparatus 1 to make the number Δ of spare additional drinks.

Moreover, even if not shown, the method of the invention can envisage that, if the check of block 103 is negative, the processing unit 60, rather than returning to block 102, blocks the operation of apparatus 1 which can then be, for example, restored only by a customer service.

Thanks to the method of the invention, apparatus 1 is enabled to make drinks (in a number at least equal to N) only when the processing unit 60 recognises an electronic card 100 identifying the type of product container for which apparatus 1 has been optimised.

This induces a user to use apparatus 1 only with containers contained in packages associated with an electronic card identifying such type of container, discouraging him/her from using apparatus 1 with unsuitable containers that could alter the quality of the drink made and impair the safety of apparatus 1.

For example, in fact, a coffee wafer containing a blend of much more coarse grinding than that for which the pressure of apparatus 1 has been set could cause the production of a very watery coffee. On the other hand, a too thin grinding could generate an excessive pressure in the hydraulic circuit, thus causing hazards and/or malfunctions of the apparatus itself.

Moreover, a coffee wafer having larger size than that for which seat 50 of apparatus 1 has been designed could cause problems of hot water leaks inside apparatus 1, which could be dangerous for the user. For example, this could occur in the case of a typical seat 50, comprising two portions adapted to be separated for allowing the user to rest the container on the lower portion of the seat and then to be approached again for incorporating the container thus inserted therein. In case of container of larger size than that of such seat, the two portions could not close perfectly one on the other, so as to cause the leaking of hot water from the seat while making the hot drink.

The Applicant notes that in case apparatus 1 can make a plurality of types of hot drinks (for example tea and coffee), it could be designed for optimising the quality of the type of hot drink each time selected by the user through the selection means 70. That is, the processing unit 60 could be designed for adjusting the water temperature and pressure inside apparatus 1 according to the type of hot drink (e.g., tea or coffee) selected by the user through the selection means 70. In fact, two types of different drinks can have different optimum pressure and/or temperature values.

In this case, the electronic card 100 will advantageously identify containers of a plurality of products (e.g., wafers of tea and coffee) having features based on which the production of apparatus 1 has been optimised.

As an alternative, it is possible to provide for a plurality of electronic card, each identifying one of the plurality of types of product containers for which the production of apparatus 1 has been optimised, and apparatus 1 will advantageously be adapted to recognise the plurality of electronic cards.

1. A method for controlling the production of an apparatus (1) for making drinks which is adapted to be used with a predetermined type of product container having predetermined features, said method comprising the steps of
a) organising containers of said predetermined type in a plurality of packages (90) each comprising a number N of said containers, where N is an integer greater than 1;
b) associating each of said packages (90) with at least one electronic card (100) identifying said predetermined type of container; and
c) at said apparatus (1) for making drinks, for each electronic card associated by a user with said apparatus (1), checking whether the electronic card associated by the user conforms with the electronic card (100) identifying said predetermined type of container and, in the affirmative case,
c1) enabling the apparatus (1) to make a predetermined number of drinks;
c2) disabling the electronic card (100) for further readings.

2. A method according to claim 1, wherein in step c1) the apparatus (1) is enabled to make also a number of spare additional drinks with respect to said predetermined number.

3. A method according to claim 1, wherein said electronic card (100) is indicative of a predetermined number M of drink supplies.

4. A method according to claim 3, wherein in step c1) said predetermined number of drinks is at least equal to M.

5. A method according to claim 3, wherein said electronic card (100) comprises means indicative of said predetermined number M of drink supplies.

6. A method according to claim 5, also comprising a step c3) of determining from said indicative means of said electronic card (100) the predetermined number M of drink supplies.

7. A method according to claim 1, wherein the electronic card (100) also comprises a casing and is adapted to identify said type of container by a suitable shape of the casing.

8. A method according to claim 7, wherein the step c) of checking the electronic card is carried out by suitable shape recognition.

9. A method according to claim 1, wherein the electronic card (100) comprises means adapted to store an identification code of said electronic card.

10. A method according to claim 9, wherein the step c) of checking the electronic card (100) is carried out by recognition of said identification code.

11. A method according to claim 5, wherein the means indicative of the predetermined number M of drink supplies comprises an electrical resistor (130) having a predetermined resistance value, indicative of number M.

12. A method according to claim 11, wherein the step c3) is carried out by a determination of the resistance value of the electrical resistor (130).

13. A method according to claim 1, wherein the product containers are single-dose containers.

14. An apparatus (1) for making drinks adapted to be used with a predetermined type of product container having predetermined features, said apparatus (1) comprising a processing unit (60) and a recognizing device (80) adapted to identify an electronic card (100) identifying said type of product container, wherein, when said recognizing device (80) identifies an electronic card complying with the electronic card (100) identifying said type of container, said processing unit (60) is adapted to:
enable the apparatus (1) to make a predetermined number of drinks; and
disable the electronic card (100) for further readings.

15. The apparatus (1) according to claim 14, further comprising
a water heating device (30);
a seat (50) adapted to receive a product container of said container type; and
a duct (40) for feeding hot water from the device (30) to the seat (50).

16. The apparatus (1) according to claim 14, wherein the processing unit (60) is also adapted to determine from the electronic card (100) a predetermined number M of supplies.

17. The apparatus (1) according to claim 16, wherein the processing unit (60) is adapted to enable apparatus (1) to make a number of drinks at least equal to M.

18. The apparatus (1) according to claim 14, wherein the recognizing means (80) is adapted to identify the electronic card (100) by suitable shape recognition.

19. The apparatus (1) according to claim 14, wherein the recognizing means (80) comprises an opening, having a shape complementary to that of the electronic card (100) for receiving the electronic card (100).

20. The apparatus (1) according to claim 14, wherein the processing unit is adapted to disable the electronic card (100) by supplying it with a current having a predetermined intensity.

21. An electronic card (100) identifying a type of product container having predetermined features, said electronic card (100) being adapted to be associated with an apparatus (1) for making drinks according to claim 14 and being adapted to allow the disabling of the electronic card (100) by said apparatus (1).

22. The electronic card (100) according to claim 21, also comprising means indicative of a predetermined number M of drink supplies.

23. The electronic card (100) according to claim 22, wherein the means indicative of a predetermined number M of drink supplies comprises means adapted to store said number M.

24. The electronic card (100) according to claim 22, wherein the means indicative of a predetermined number M of drink supplies comprises an electrical resistor (130) having a predetermined resistance value, indicative of number M.

25. The electronic card (100) according to of claim 21, wherein the means adapted to allow the disabling of the electronic card (100) comprises an electrical resistor (130) and a fuse (110) electrically connected to one another.

26. A package (90) comprising N product containers of a predetermined type having predetermined features, where N is an integer greater than 1, and an electronic card, identifying said type of container, according to claim 21.
